(19) United States
(12) Patent Application Publication
(10) Pub. No.: US 2023/0311383 A1
(43) Pub. Date: Oct. 5, 2023

(54) REINFORCEMENT FIBER CONVEYING APPARATUS, REINFORCEMENT FIBER SUPPLYING STAND, INJECTION MOLDING APPARATUS, REINFORCEMENT FIBER CONVEYING METHOD, AND REINFORCEMENT FIBER SUPPLYING METHOD

(71) Applicant: THE JAPAN STEEL WORKS, LTD., Tokyo (JP)

(72) Inventors: Daisuke KUNIHIRO, Tokyo (JP); Mitsuhide UMEDA, Tokyo (JP)

(21) Appl. No.: 18/111,575

(22) Filed: Feb. 19, 2023

(30) Foreign Application Priority Data
Mar. 31, 2022 (JP) 2022-058503

(51) Int. Cl. B29C 45/18; B29C 45/00; B29C 70/16

(52) U.S. Cl. CPC B29C 45/1816; B29C 45/0005; B29C 70/16; B29C 2045/1765

(57) ABSTRACT

A reinforcement fiber conveying apparatus, comprises: a reinforcement fiber conveying tubular body having one end arranged in a vicinity of a reinforcement fiber body comprised of a reinforcement fiber that is continuously pulled out and the other end arranged in a vicinity of a reinforcement fiber supplying port formed in a heating cylinder used for injection molding; and an air flow generation unit configure to generate an air flow from the one end toward the other end in the reinforcement fiber conveying tubular body.

### INCORPORATION BY REFERENCE

This application is based upon and claims the benefit of priority from Japanese patent application No. 2022-058503, filed on Mar. 31, 2022, the disclosure of which is incorporated herein in its entirety by reference.

### BACKGROUND

The present disclosure relates to a reinforcement fiber conveying apparatus, a reinforcement fiber supplying stand, an injection molding apparatus, a reinforcement fiber conveying method, and a reinforcement fiber supplying method.

Japanese Unexamined Patent Application Publication No. 2020-142390 discloses an injection molding apparatus. The injection molding apparatus conveys thermoplastic resin (multiple resin pellets) supplied from an upstream side (a hopper) to a downstream side while melting it by heat conveyed from a heating cylinder and heat caused by shearing due to the rotation of a screw. The injection molding apparatus then kneads the conveyed molten resin with reinforcement fibers, which are additives supplied from a middle (from a fiber supplying port formed in the heating cylinder). The injection molding apparatus then injects the molten resin kneaded with the reinforcement fibers into a mold. As a result, a molded product is molded (direct molding).

### SUMMARY

In Japanese Unexamined Patent Application Publication No. 2020-142390, when there is more than one reinforcement fiber body comprised of a reinforcement fiber that is continuously pulled out (for example, more than one roving body comprised of a roving that is a reinforcement fiber wound in a cylindrical shape), there is no mention of efficiently conveying the reinforcement fiber (s) pulled out from each reinforcement fiber body to the injection molding apparatus without the need for a worker to convey them, and there is room for improvement in this regard.

Other objects and novel features will be apparent from the description and accompanying drawings herein.

According to an embodiment, a reinforcement fiber conveying apparatus includes: a reinforcement fiber conveying tubular body having one end arranged in a vicinity of a reinforcement fiber body comprised of a reinforcement fiber that is continuously pulled out and the other end arranged in a vicinity of a reinforcement fiber supplying port formed in a heating cylinder used for injection molding; and an air flow generation unit configure to generate an air flow from the one end toward the other end in the reinforcement fiber conveying tubular body.

According the above-described embodiment, it is possible to provide a reinforcement fiber conveying apparatus, a reinforcement fiber supplying stand, an injection molding apparatus, a reinforcement fiber conveying method, and a reinforcement fiber supplying method which can convey efficiently the reinforcement fiber (s) pulled out from each reinforcement fiber body to the injection molding apparatus, when there is more than one reinforcement fiber body comprised of a reinforcement fiber that is continuously pulled out (for example, more than one roving body comprised of a roving that is a reinforcement fiber wound in a cylindrical shape).

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a schematic view of the injection molding apparatus 1, the reinforcement fiber supplying stand 80 and the reinforcement fiber conveying apparatus 90;

FIG. 2 is a diagram showing the overall configuration of the injection molding apparatus 1 according to the embodiment;

FIG. 3 is a perspective view of the heating cylinder 17;

FIG. 4 is an enlarged view (schematic view) of the vicinity of the additive supplying port 17b formed in the heating cylinder 17;

FIG. 5 is a top view (schematic) of the reinforcement fiber supplying stand 80; and

FIG. 6 shows an example of the air flow generation unit 92.

### DESCRIPTION OF EMBODIMENTS

Specific embodiments will be described hereinafter in detail with reference to the drawings. However, the present disclosure is not limited to the below-shown embodiments. Further, the following descriptions and the drawings are simplified as appropriate for clarifying the explanation.

First, the outline of an injection molding apparatus 1, a reinforcement fiber supplying stand 80, and a reinforcement fiber conveying apparatus 90 will be described.

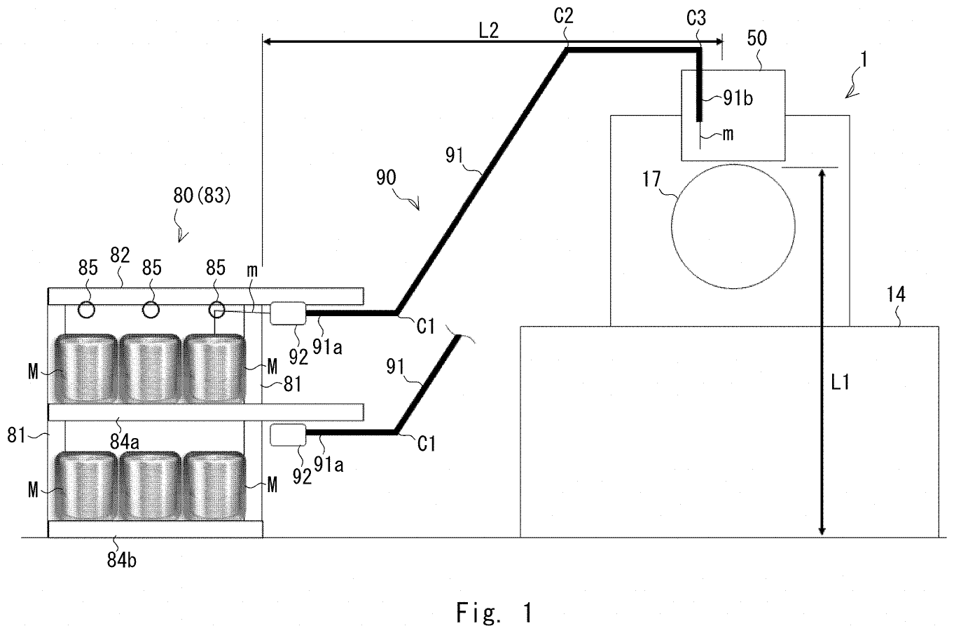

FIG. 1 is a schematic view of the injection molding apparatus 1, the reinforcement fiber supplying stand 80 and the reinforcement fiber conveying apparatus 90.

As shown in FIG. 1, the injection molding apparatus 1 is a large injection molding machine with a height L1 and is installed on a bed 14. L1 is, for example, 2.7 m.

The injection molding apparatus 1 conveys thermoplastic resin (multiple resin pellets) supplied from an upstream side (a hopper 20) to a downstream side while melting it by heat conveyed from a heating cylinder 17 and heat caused by shearing due to the rotation of a screw 18 for direct molding provided inside the heating cylinder 17. The injection molding apparatus 1 then kneads the conveyed molten resin with additives supplied from a middle (from an additive supplying port 17b formed in the heating cylinder 17). The injection molding apparatus 1 then injects the molten resin kneaded with the additives into a mold (a fixed mold 21 and a movable mold 25 which are mold-clamped). Thereby, a molded product (a molded product with evenly distributed additives) is molded (direct molding). In FIG. 1, the screw 18 for direct molding, the additive supplying port 17b, the fixed mold 21 and the movable mold 25 are omitted.

In this embodiment, a roving (for example, a glass fiber, a carbon fiber), which is a reinforcement fiber that is continuously pulled out from a roving body M, is used as the additive. The roving body M is a reinforcement fiber body comprised of a roving, which is a reinforcement fiber, wound in a cylindrical shape. The roving body M is generally distributed as a roving. The roving body M is placed on the reinforcement fiber supplying stand 80.

The reinforcement fiber supplying stand 80 is arranged on the side of the injection molding apparatus 1. The distance L2 to the injection molding apparatus 1 is, for example, 3.0 m.

The reinforcement fiber conveying apparatus 90 conveys the roving that is pulled out from the roving body M from one end 91a to the other end 91b of a reinforcement fiber conveying tubular body 91 by the reinforcement fiber conveying tubular body 91. The one end 91a is arranged in the vicinity of the reinforcement fiber body M. The other end 91b is arranged in the vicinity of the additive supplying port 17b formed in the heating cylinder 17. A worker grasps the roving m conveyed to the other end 91b and the grasped roving m is supplied through the additive supplying port 17b.

### <Overall Configuration of the Injection Molding Apparatus>

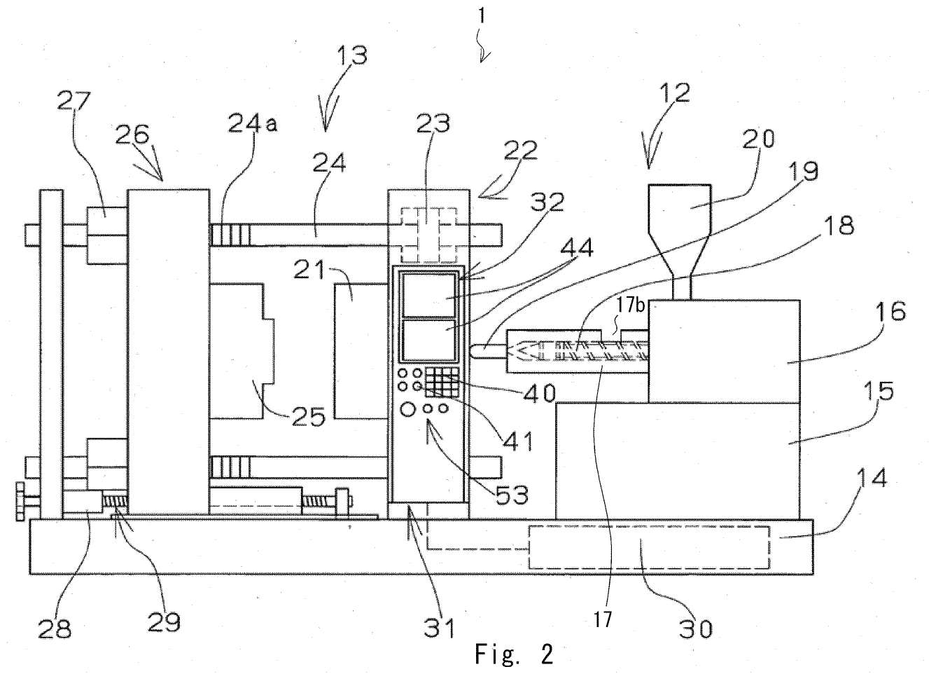

Next, the overall configuration of the injection molding apparatus 1 (an injection molding machine) according to the present embodiment will be described with reference to FIG. 2. FIG. 2 is a diagram showing the overall configuration of the injection molding apparatus 1 according to the embodiment.

As shown in FIG. 2, the injection molding apparatus 1 comprises a plasticizing unit 12 (an injection apparatus) and a mold-clamping unit 13.

### <Configuration of the Plasticizing Unit>

The plasticizing unit 12 is mainly comprises a heating cylinder 17, a screw 18 for direct molding (hereafter referred to simply as the screw 18) provided inside the heating cylinder 17, and a hopper 20 configured to supply thermoplastic resin (multiple resin pellets).

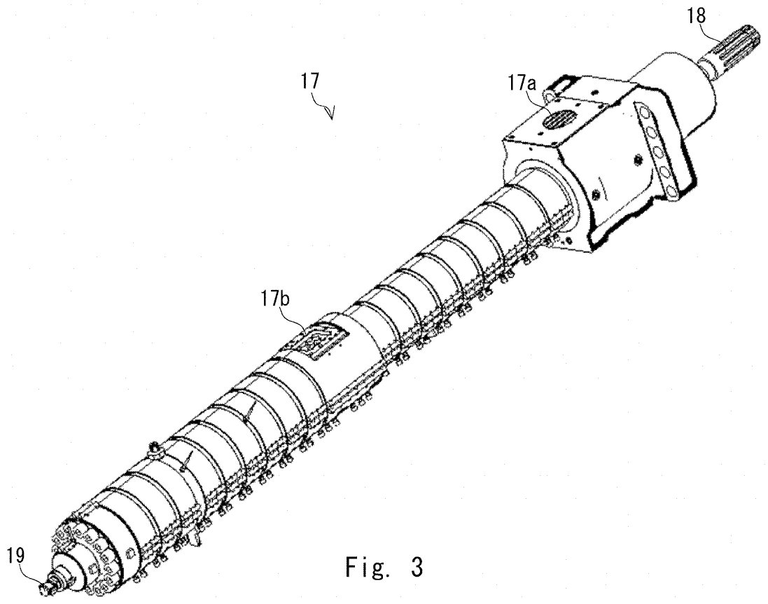

FIG. 3 is a perspective view of the heating cylinder 17.

As shown in FIG. 3, the heating cylinder 17 is a cylindrical cylinder. On an upstream side of the heating cylinder 17, a resin supplying port 17a into which thermoplastic resin (multiple resin pellets) is supplied is formed. And on a middle between the upstream side and the downstream side of the heating cylinder 17, an additive supplying port 17b into which an additive is supplied is formed. At the downstream end of the heating cylinder 17, an injection nozzle 19 is provided configured to inject the molten resin kneaded with additives.

As shown in FIG. 2, the plasticizing unit 12 comprises a mechanism unit 16 including an injection servomotor, etc., that controls the rotation and axial advance and retreat of the screw 18, and a control device 30 that controls (an injection and packing control in an injection process, a back pressure control in a weighing process, etc.) the mechanism unit 16. The control device 30 also controls a mold-clamping cylinder 23 (a hydraulic apparatus) and the servomotor 28 for opening and closing the mold, which will be described later. In FIG. 2, the symbol 14 indicates a bed in which the plasticizing unit 12 and the mold-clamping unit are installed. The symbol 15 indicates a base installed on the bed 14. The mechanism unit 16 is installed on the base 15.

### <Configuration of the Mold-Clamping Unit 13>

As shown in FIG. 2, the mold-clamping unit 13 comprises a fixed plate 22 to which a fixed mold 21 is attached and a movable plate 26 to which a movable mold 25 is attached. A mold-clamping cylinder 23 is arranged in the vicinity of the four corners of the fixed plate 22, and the rod of the mold-clamping cylinder 23 constitutes a tie bar 24. A groove-like half-nut locking part 24a is formed from the middle to a tip of the outer circumference of the tie bar 24. The mold-clamping cylinder 23 is connected to a hydraulic apparatus (not shown), and a hydraulic pressure of the hydraulic fluid sent to the mold-clamping cylinder 23 is detected by a pressure sensor provided in a tubular body to control the mold-clamping force.

The tie bar 24 are inserted into through holes formed in the vicinity of the four corners of the movable plate 26. Half-nuts 27 are respectively provided around the through-holes through which the tie bar 24 is inserted on the rear side of the movable plate 26. A mold opening/closing mechanism 29 comprised of a mold opening/closing servomotor 28 and a ball screw mechanism is provided on the bed 14, and the movable plate 26 can move on the bed 14 in the mold opening/closing direction by the mold opening/closing mechanism 29. In FIG. 2, the symbol 31 indicates an operating device, the symbol 32 indicates a display device of the operating device 31, the symbol 40 indicates various operating keys, the symbol 41 indicates various switches, the symbol 44 indicates each screen of the display device 32, and the symbol 53 indicates an operating section.

### <Mold-Clamping Unit Operation>

First, the movable plate 26 is moved by controlling the mold opening/closing servomotor 28 so that the fixed mold 21 comes into contact with the movable mold 25. Then, the movable plate 26 is fixed to the tie bar 24 by engaging the half-nut locking part 24a of the tie bar 24 with the half nut 27. Then, by controlling the mold-clamping cylinder 23, the fixed mold 21 and the movable mold 25 are tightened. After the mold clamping is performed in this way, a molded product (a molded product with evenly distributed additives) is molded by injecting the molten resin (the molten resin kneaded with the reinforcement fibers) from the plasticizing unit 12 into a cavity of the mold (the fixed mold 21 and the movable mold 25 which are mold-clamped).

### <Composition of a Reinforcement Fiber Supplying Box>

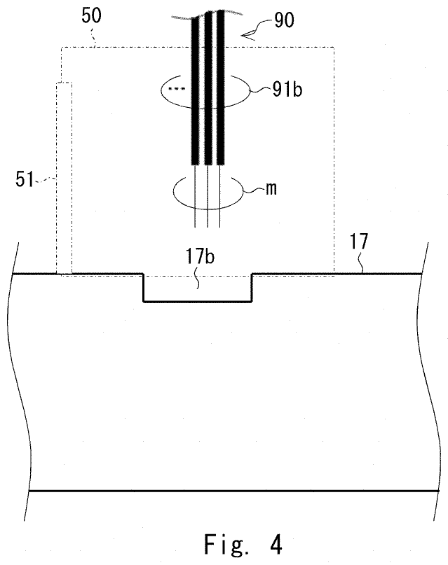

FIG. 4 is an enlarged view (schematic view) of the vicinity of the additive supplying port 17b formed in the heating cylinder 17.

As shown in FIGS. 1 and 4, the reinforcement fiber supplying box 50 provided with a door 51 with an electric lock (interlock) is arranged above the additive supplying port 17b (one example of a reinforcement fiber supplying port in this disclosure) formed in the heating cylinder 17. The door 51 (the electric lock) is controlled by the control device so as not to open while, for example, the screw 18 is being driven. In the reinforcement fiber supplying box 50, the other end 91b of the reinforcement fiber conveying tubular body 91 is arranged. By opening the door 51, a worker accesses the roving m conveyed to the other end 91b of the reinforcement fiber conveying tubular body 91, as described later, and grasps the roving m and supplies it through the additive supplying port 17b.

### <Composition of a Reinforcement Fiber Supplying Stand 80>

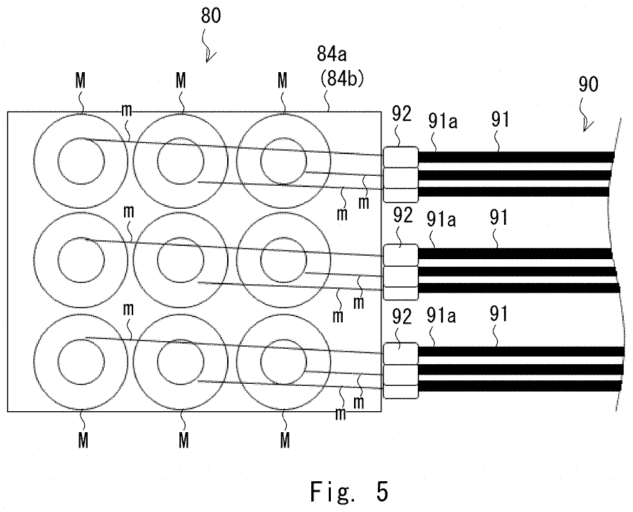

FIG. 5 is a top view (schematic) of the reinforcement fiber supplying stand 80.

As shown in FIGS. 1 and 5, roving bodies M are placed on each stage (a roving body placing tables 84a, 84b) of the reinforcement fiber supplying stand 80.

As shown in FIG. 1, the reinforcement fiber supplying stand 80 comprises a stand body 83 comprised of a combination of a vertical frame 81 and a horizontal frame 82, a roving body placing tables 84a and 84b supported by the stand body 83, and the eye bolt 85 through which the roving m pulled out from the roving body M is passed. The eye bolt 85 is provided on the stand body 83.

### <Configuration of the Reinforcement Fiber Conveying Apparatus 90>

As shown in FIGS. 1 and 4, the reinforcement fiber conveying apparatus 90 comprises a reinforcement fiber conveying tubular body 91 and an air flow generation unit 92. One end 91a of the reinforcement fiber conveying tubular body 91 is arranged in the vicinity of the roving body M, and the other end 91b is arranged in the vicinity of the additive supplying port 17b formed in the heating cylinder 17. The air flow generation unit 92 generates an air flow from one end 91a to the other end 91b in the reinforcement fiber conveying tubular body 91. It should be noted that a plurality of combinations of the reinforcement fiber conveying tubular body 91 and the air flow generation unit 92 are provided corresponding to the plurality of roving bodies M. The roving m pulled out from each roving body M is conveyed by each corresponding reinforcement fiber conveying tubular body 91.

The reinforcement fiber conveying tubular body 91 is, for example, a metal pipe in which three bent parts C1 to C3 are formed along the way. The reinforcement fiber conveying tubular body 91 is long and hollow like a tube or pipe. The cross-sectional shape of the reinforcement fiber conveying tubular body 91 is not limited to round, but may be rectangular or any other shape. One end 91a of the reinforcement fiber conveying tubular body 91 is provided with an air flow generation unit 92. The air flow generation unit 92 is attached to the stand body 83.

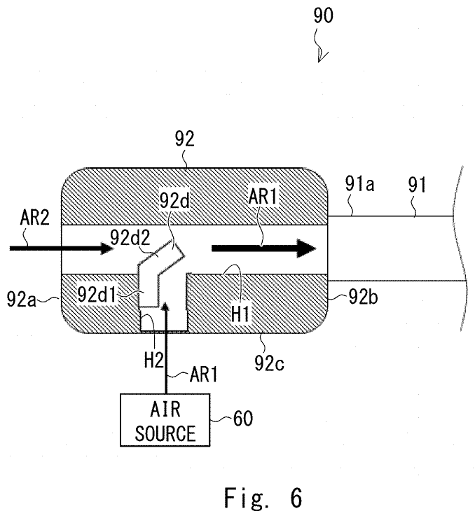

FIG. 6 shows an example of the air flow generation unit 92.

The air flow generation unit 92 is a cylindrical member made of plastic or metal. As shown in FIG. 6, a first through-hole H1 penetrating one end face 92a and the other end face 92b and communicating with the reinforcement fiber conveying tubular body 91, and a second through-hole H2 penetrating a side face 92c and the inner wall of the first through-hole H1 and communicating with the first through-hole H1 are formed in the air flow generation unit 92. An air source 60 (for example, an air pump) configured to supply air is connected to the second through-hole H2. If piping configured to supply air is installed in a factory where the reinforcement fiber supplying stand 80 or the like is installed, the piping may be used as the air source 60. In FIG. 6, arrow AR1 represents air supplied from the air source 60.

Air from the air source 60 is supplied to the first through-hole H1 through the second through-hole H2. At that time, the air supply direction from the air source 60 in the first through-hole H1 is directed to the other end 91b side of the reinforcement fiber conveying tubular body 91 by an air flow direction changing member 92d provided on the inner wall of the second through-hole H2. The air flow direction changing member 92d includes a fixed portion 92d1 fixed to the inner wall of the second through-hole H2 and a sloped portion 92d2 extending in the direction inclined from the fixed portion 92d1 to the reinforcement fiber conveying tubular body 91 side.

Due to the air flow whose supply direction is changed by the air flow direction changing member 92d, the portion (the left portion in FIG. 6) of the first through-hole H1 upstream from the second through-hole H2 becomes low pressure. As a result, a suction force (see arrow AR2 in FIG. 6) is generated on the inlet side of the first through-hole H1 (left side in FIG. 6). The roving m pulled out from the roving body M is sucked into the first through-hole H1 by the suction force.

As described above, the air flow from one end 91a to the other end 91b is generated in the reinforcement fiber conveying tubular body 91. The roving m sucked into the first through-hole H1 is conveyed from one end 91a to the other end 91b in the reinforcement fiber conveying tubular body 91 by the air flow.

Next, an example of a method of conveying the roving m pulled out from the roving body M and a method of supplying the conveyed roving m will be briefly explained.

First, by driving the air source 60, the air flow from one end 91a to the other end 91b is generated in the reinforcement fiber conveying tubular body 91. As a result, the portion (the left portion in FIG. 6) of the first through-hole H1 upstream from the second through-hole H2 becomes low pressure, and as a result, the suction force (see arrow AR2 in FIG. 6) is generated on the inlet side of the first through-hole H1 (left side in FIG. 6).

Then, a worker moves the roving m, which is pulled out from the roving body M and passed through the eye bolt 85, closer to one end 91a (the air flow generation unit 92) of the reinforcement fiber conveying tubular body 91 corresponding to the roving body M.

The roving m approaching one end 91a (the air flow generation unit 92) is sucked into the first through-hole H1 by the suction force generated on the inlet side of the first through-hole H1 (the left portion in FIG. 6) as described above. Then, the sucked roving m is conveyed from one end 91a to the other end 91b in the reinforcement fiber conveying tubular body 91 by the air flow generated in the reinforcement fiber conveying tubular body 91 and flowing from one end 91a to the other end 91b as described above. The above work is performed for each roving body M.

Next, the worker opens the door 51 of the reinforcement fiber supplying box 50, grasps the roving m (s) conveyed to the other end 91b of the reinforcement fiber conveying tubular body 91, and supplies them through the additive supplying port 17b.

As described above, according to the embodiment, when there is more than one roving body M comprised of a roving m that is a reinforcement fiber wound in a cylindrical shape, it is possible to convey efficiently the reinforcement fiber (s) pulled out from each reinforcement fiber body to the injection molding apparatus 1 without the need for a worker to convey them.

At that time, a plurality of combinations of the reinforcement fiber conveying tubular body 91 and the air flow generation unit 92 are provided corresponding to the plurality of roving bodies M. As a result, the roving m (s) pulled out from each roving body M is prevented from entangling with each other in the process of being conveyed.

In addition, according to the embodiment, since the other end 91b of each reinforcement fiber conveying tubular body 91 is arranged in the vicinity of the additive supplying port 17b formed in the heating cylinder 17, the roving m (s) conveyed by each reinforcement fiber conveying tubular body 91 can be efficiently grasped and supply through the additive supplying port 17b.

In addition, according to the embodiment, the other end 91b of the reinforcement fiber conveying tubular body 91 is arranged in the reinforcement fiber supplying box 50 provided with the door 51 with the electric lock (interlock). As a result, by opening the door 51 at the appropriate time, a worker can access the roving m (s) conveyed to the other end 91b of the reinforcement fiber conveying tubular body 91, and grasps the roving m (s) and supplies them through the additive supplying port 17b.

As described above, the invention made by the inventor is explained in detail based on the embodiment, but this disclosure is not limited to the previously described embodiment, and it goes without saying that various modifications are possible without departing from the gist of the disclosure.

Needless to say, the present invention is not limited to the foregoing embodiments and may be applied to modifications made by those skilled in the art on the basis of the meaning of the present invention, although not enumerated herein. Moreover, in the present invention, a plurality of examples described in the foregoing embodiments and the modifications may be appropriately combined.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A reinforcement fiber conveying apparatus, comprising:
a reinforcement fiber conveying tubular body having one end arranged in a vicinity of a reinforcement fiber body comprised of a reinforcement fiber that is continuously pulled out and the other end arranged in a vicinity of a reinforcement fiber supplying port formed in a heating cylinder used for injection molding; and
an air flow generation unit configure to generate an air flow from the one end toward the other end in the reinforcement fiber conveying tubular body.

2. The reinforcement fiber conveying apparatus according to claim 1, wherein
the reinforcement fiber conveying tubular body has the air flow generation unit.

3. The reinforcement fiber conveying apparatus according to claim 1, wherein
a plurality of the reinforcement fiber conveying tubular bodies is provided corresponding to a plurality of the reinforcement fiber body.

4. The reinforcement fiber conveying apparatus according to claim 1, further comprising
a reinforcement fiber supplying box arranged above the reinforcement fiber supplying port and provided with a door with electric lock, wherein
the other end of the reinforcement fiber conveying tubular body is arranged in the reinforcement fiber supplying box.

5. The reinforcement fiber conveying apparatus according to claim 1, wherein
the reinforcement fiber body is a roving body comprised of a roving that is a reinforcement fiber wound in a cylindrical shape.

6. A reinforcement fiber supplying stand, comprising:
a reinforcement fiber conveying apparatus according to claim 1;
a placing table on which the reinforcement fiber body is placed; and
a stand body configured to support the placing table.

7. The reinforcement fiber supplying stand according to claim 6, wherein
the air flow generation unit is attached to the stand body.

8. An injection molding apparatus, comprising: a reinforcement fiber conveying apparatus according to claim 1.

9. An injection molding apparatus, comprising: a reinforcement fiber supplying stand according to claim 6.

10. A reinforcement fiber conveying method, comprising the processes of:
generating an air flow from one end to the other end in the reinforcement fiber conveying tubular body which has one end arranged in a vicinity of a reinforcement fiber body comprised of a reinforcement fiber that is continuously pulled out and the other end arranged in a vicinity of a reinforcement fiber supplying port formed in a heating cylinder used for injection molding; and
bringing the reinforcement fiber pulled out from the reinforcement fiber body closer to the one end, and conveying it to the other end by the air flow.

11. A reinforcement fiber supplying method, comprising the processes of:
generating an air flow from one end to the other end in the reinforcement fiber conveying tubular body which has one end arranged in a vicinity of a reinforcement fiber body comprised of a reinforcement fiber that is continuously pulled out and the other end arranged in a vicinity of a reinforcement fiber supplying port formed in a heating cylinder used for injection molding;
bringing the reinforcement fiber pulled out from the reinforcement fiber body closer to the one end, and conveying it to the other end by the air flow; and
supplying the reinforcement fiber conveyed to the other end through the reinforcement fiber supplying port.
